(19) United States
(12) Patent Application Publication
(10) Pub. No.: US 2007/0095930 A1
(43) Pub. Date: May 3, 2007

(54) INSTALLATION, DEVICE AND METHOD FOR SAVING WATER

(76) Inventor: Josep Roura Alemany, Palafolls (Barcelona) (ES)

Correspondence Address: DARBY & DARBY P.C., P. O. BOX 5257, NEW YORK, NY, 10150-5257, US

(21) Appl. No.: 11/611,749

(22) Filed: Dec. 15, 2006

Related U.S. Application Data
(63) Continuation of application No. PCT/ES05/00333, filed on Jun. 13, 2005.

(30) Foreign Application Priority Data
Jun. 15, 2004 (ES) 200401458
Jul. 13, 2004 (ES) 200401709
May 16, 2005 (ES) 200501177

(51) Int. Cl. G05D 23/185; G05D 23/13

(52) U.S. Cl. 236/12.11; 236/12.16

(57) ABSTRACT

Installation for the consumption of running water, of the type comprising hot and cold water circuits and at least one water dispensing point common to both circuits, characterised in that the cold water circuit operates at lower pressure than the hot water circuit; by at least one device located at a common water dispensing point for the hot and cold circuits, which comprises a control element which can be actuated by the user, which allows the passage of water from the hot water circuit to the cold water circuit via the water dispensing point, and, preferably, a device which determines, by means of means sensitive to temperature, the time during which both circuits are in communication; and by means located in the cold water circuit for the discharge of the volume of water deriving from the hot water circuit.

The present invention is intended to disclose an installation, a device and a method for saving water.

The present invention is intended to increase the saving of water and comfort, especially in installations for the consumption of running water (both in existing and in new buildings), which are provided with hot and cold water circuits and with common water dispensing points for both circuits.

This type of installation is found, for example, in modern residential properties which currently are provided, in their entirety, with hot water for sanitary purposes.

In these installations, when the user requests hot water from a water dispensing point, usually the tap, a certain period of time must elapse before the temperature of the water emerging via this water dispensing point reaches the required temperature. This is a disadvantage, because contact with cold water is always an irritation, especially in the case of babies and young children. Accordingly, habitually the water is allowed to flow from the water dispensing point until the temperature required by the user has been reached. This involves an unnecessary waste of water, at a time at which the saving of water is a matter of major concern to the authorities.

To resolve this problem, the prior art has offered various solutions, which exhibit certain disadvantages.

The documents U.S. Pat. No. 6,098,213 and U.S. Pat. No. 4,924,536 disclose an energy-saving device and a running water installation for the same purpose, in which the hot water which has not reached the required temperature is diverted to a specific ancillary filling circuit for the tank of a water closet.

These installations have the disadvantage that they require the arrangement of an installation of specific pipes from each water dispensing point to the tank of the closet. In addition, the devices disclosed in the said documents are only applicable with difficulty to existing taps, since they require a specific location for their installation. In addition, no harnessing of the energy takes place from the water which is diverted to the tank.

The document CA 2252350 discloses a water consumption installation in which the hot water which does not reach the required temperature is diverted to an intermediate tank in the cold water circuit, which also requires the installation of long pipes from each water dispensing point to the intermediate tank, which renders it difficult to apply to existing installations. On the other hand, the obtaining of adequate pressure in the cold water circuit requires the placement of an intermediate tank in an excessively high position, and no harnessing of energy takes place from the hot water send to the tank.

The present invention has the following objects:
To provide hot water without the user coming in contact with the cold water
To achieve a substantial and simultaneous saving of water and energy,
To contribute to current environmental policy without causing the disadvantages referred to heretofore.

All this to be achieved with means which assume a minimum investment in comparison with the savings and convenience obtained, and of easy application to existing installations.

In order to achieve these objects, the present invention consists of a method for the saving of water in installations for the consumption of running water, of the type comprising cold water and hot water circuits, and at least one common water dispensing point, which comprises a transfer of water from the hot water circuit to the cold water circuit, via the water dispensing point, prior to the consumption of hot water, during a period of time such that, at the end of the transfer, the water from the hot water circuit at the water dispensing point has the required temperature. In this way it is possible to increase the convenience of the installation. The water transferred to the cold water circuit can be exploited subsequently, which in this way achieves an appreciable saving of energy. The transfer of the water via the water dispensing point renders unnecessary the provision of pipes specifically for the exploitation of this water.

The subsequent exploitation of the water transferred to the cold water circuit can comprise intermediate storage and subsequent transfer of the stored water to a water dispensing point of the installation by way of the installation itself.

Preferably, the method includes the transfer of the water from the cold water circuit to a point in the water installation upstream of a hot water generator located in the hot water circuit of the installation.

This configuration allows to advantage for the intermediate storage to be done away with. In addition to this, by means of this preferred embodiment it is possible to achieve better harnessing of the energy from the hot water by means of the generator of the hot water which has not reached the required temperature.

Likewise, the present invention consists of an installation for the consumption of running water, of the type comprising hot and cold water circuits and at least one common water dispensing point for both circuits, characterised:
in that the cold water circuit operates at lower pressure than the hot water circuit,
by at least one device located at a common water dispensing point for the hot and cold water circuits, which comprises a control element which can be actuated by the user, allowing water to pass from the hot water circuit to the cold water circuit via the water dispensing point, and, preferably, a device which determines, by way of temperature-sensitive means, the time during which both circuits are in communication, and
by means located in the cold water circuit for the discharge of the volume of water deriving from the hot water circuit.

Preferred embodiments of the invention are characterised by the provision means of reusing the water in the intermediate tank.

In preferred embodiments, means are provided which allow for the reuse of the water from the intermediate tank by way of the installation, when consumption takes place in the installation, causing the stored water to return to the water circuits for consumption at the water dispensing points.

Preferably, the means of discharge comprise devices for shutting off the intake of water into the cold water circuit and opening the discharge mechanism, and means sensitive to the pressure of the cold water circuit.

Preferably, the said means of discharge comprise time-sensitive means, which regulate the opening and closing time of the said devices for opening the discharge mechanism and closing the cold water circuit.

More preferably, the means of discharge of the volume of water deriving from the hot water circuit of the installation comprise means for the transfer of water from the cold water circuit at a point of the installation upstream of the hot water generator of the installation, without intermediate storage of the water.

Thanks to this configuration, it is possible to dispense with the said tank, which achieves a saving of space, as well as a reduction of the costs of providing the installation.

In a preferred embodiment, the said means for transferring water from the cold water circuit to the hot water circuit comprise a pump and a retention valve.

The device for saving water located at the water dispensing points can be configured as a manual valve, of known type, which connects the cold water circuit to the hot water circuit, which lacks of temperature-sensitive means, the user being responsible for determining the connection time for the two circuits and if the temperature of the water at the water dispensing point has reached the required temperature.

In this way, it is possible to achieve an additional saving with regard to the costs of the investment in the installation.

In a number of preferred embodiments, the time-sensitive means comprise a timer, of which the actuation time is determined during installation.

Preferred embodiments are also characterised by being provided with means which render the said means of reutilisation of the water inactive when the water discharge mechanism is in operation.

Likewise, preferred embodiments of the said device located at the water dispensing points are characterised by being capable of being connected to the taps known from the market.

The communication time between the hot and cold water circuit can be determined by temperature-sensitive means, or can be fixed, being adjusted during the installation of the device.

Likewise, in order to achieve the object of disclosing means of economising which can be easily applied to existing installations, the present invention also comprises a device for saving energy in the realisation of an installation or of the method according to the present invention, of a type which can be connected to taps for common water dispensing points for hot and cold water circuits, which comprises a control element which can be actuated by the user and temperature-sensitive means by means of which the operational position of the device can be determined, characterised in that it comprises:
a body which can be connected to the outlet from the tap;
a through-opening for the passage of the water deriving from the tap to consumption;
a blocking element for the said through-opening;
means for causing the movement of the blocking element, with the subsequent unblocking of the through-opening, and
means for controlling the said movement of the said blocking device, as a function of the said temperature-sensitive means.

Said temperature-sensitive means may comprise a heat-sensitive spring.

Said means for causing the movement of the blocking element may comprise a spring.

Said means for controlling the said blocking device can comprise a mechanism with a releasable detent means capable of exercising resistance to the force exercised by the spring of the said means for causing the movement of the blocking element.

Said user control element can be such as to allow the user to place the device in a position in which the passage of the water is blocked and the said detent means blocks the movement of the blocking mechanism.

The device can incorporate a filter at its water outlet.

The detent means can comprise a piece of variable section, the movement of which is governed by the heat-sensitive detent means, the movement of the piece of variable section causing, in its turn, the movement of a piece provided with a runner, into which said variable section is introduced, said piece providing a detent means for said blocking element, as well as by resilient recovery means which ensure the contact of the variable section with one of the ends of the runner.

The control element can consist of an actuatable button which presses the detent means of the means for causing the movement of the blocking element, allowing for the automatic resetting of the detent means into its initial position blocking said resilient force.

In this way, when the customer requires hot water, he first actuates the control element for the device and turns the tap on. Accordingly, the economising device blocks the outflow of water from the tap until the water has reached the required temperature, at which moment the dilation of the heat-sensitive detent means brings about the movement of the plug, which in turn brings about the movement of the piece with the runner, which in turn unblocks the blocking mechanism, allowing for the resilient means to open the through-opening of the device, this allowing the passage of the hot water for consumption. During the period during which the device remains closed, the water passes from the hot water circuit to the cold water circuit, in order to save it.

For better understanding, drawings are appended hereto by way of explanation, but not limitation, of a preferred embodiment of the present invention.

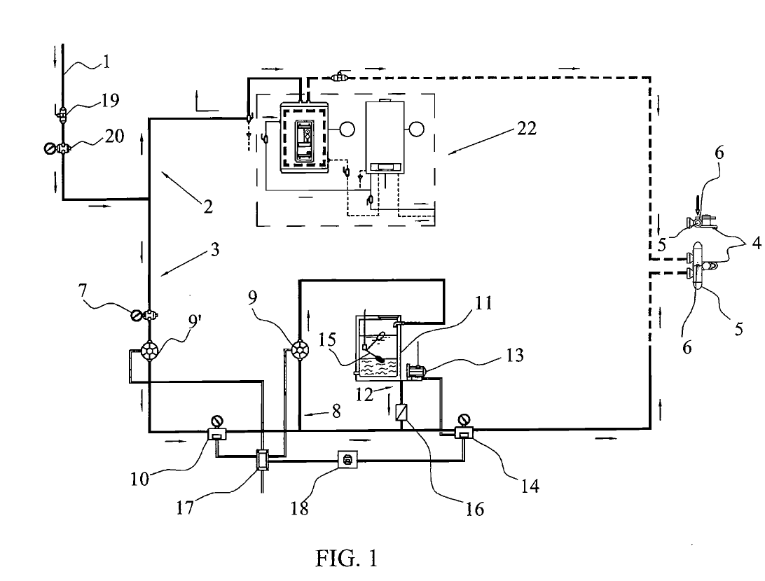

FIG. 1 is a diagrammatic representation of an installation for the consumption of running water in accordance with the present invention.

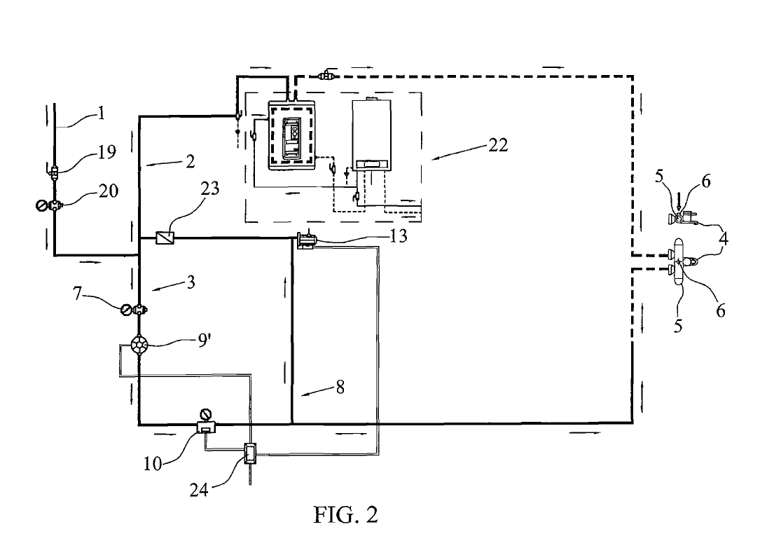

FIG. 2 shows a diagrammatic representation of an installation for running water.

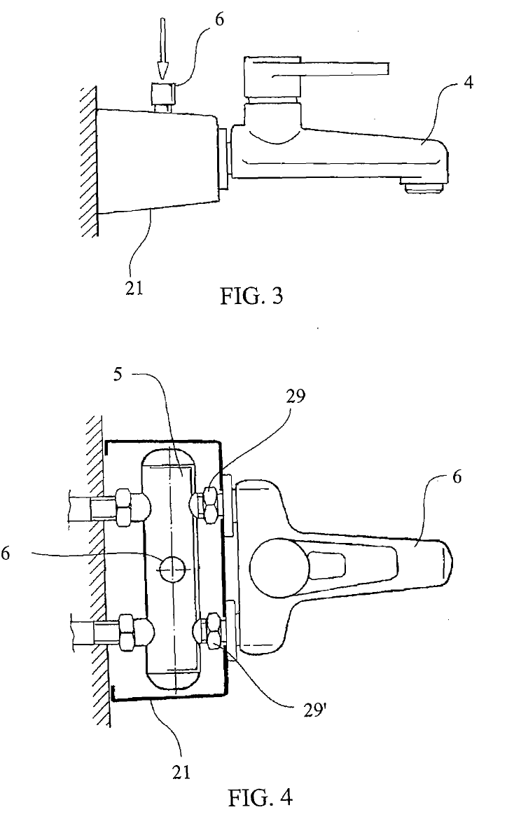

FIG. 3 is a side view of a water-saving device according to the present invention, connected to a tap for hot and cold water.

FIG. 4 is a plan view of the device from FIG. 3, in which the internal elements of the water-saving device can be seen, and its connection to the water circuit and to the tap.

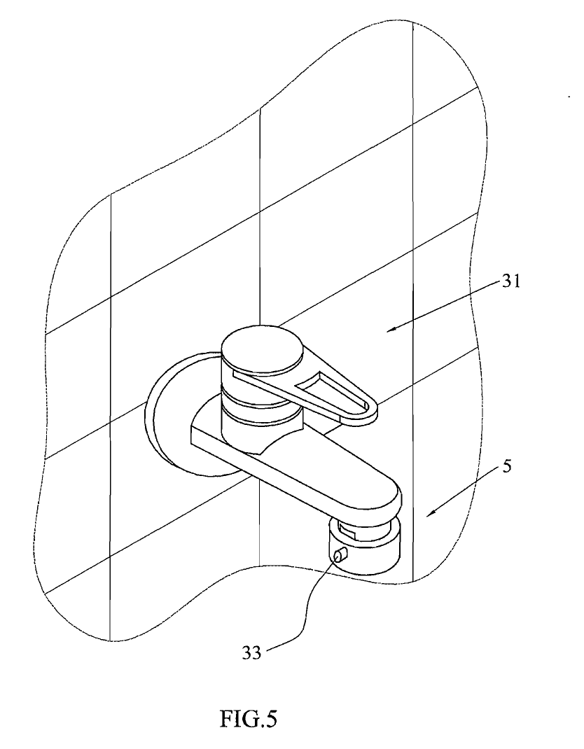

FIG. 5 shows a perspective view of a domestic tap, provided with a device according to the present invention.

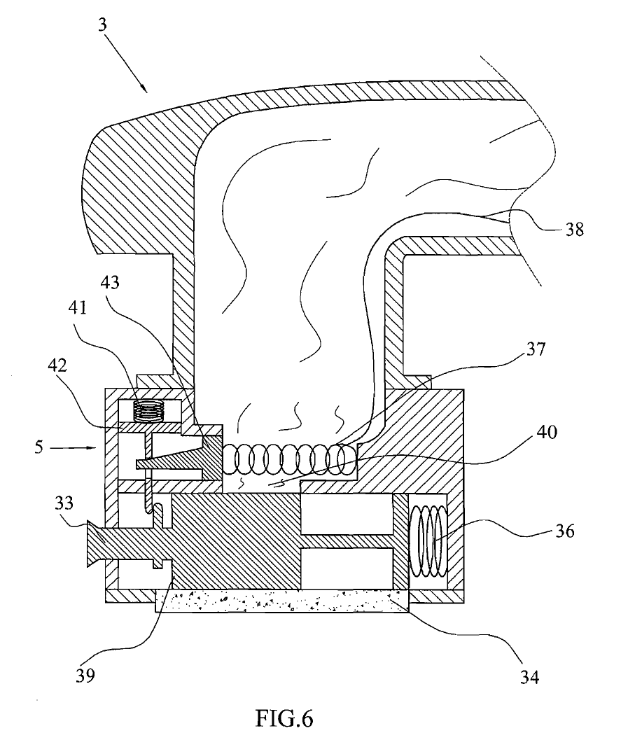

FIG. 6 is a view from above of the internal elements of the device with the mechanism blocking the outlet of water from the tap.

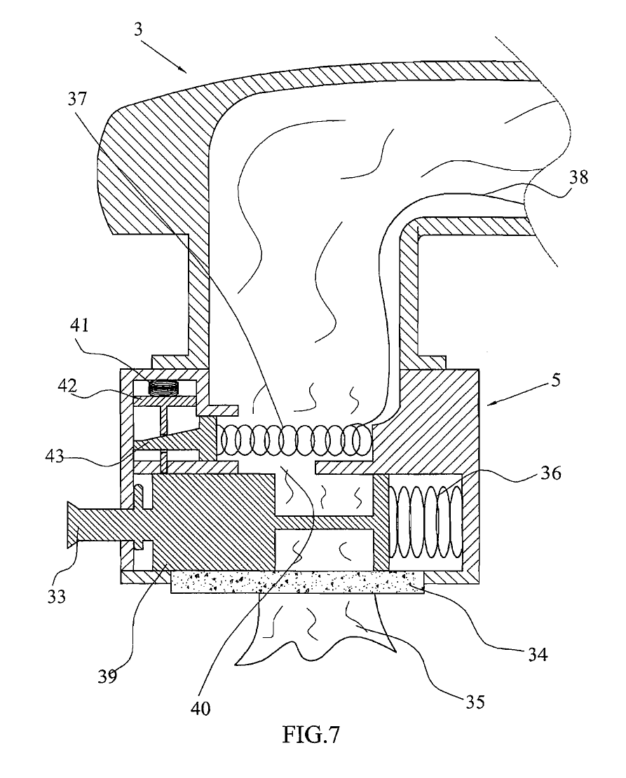

FIG. 7 corresponds to FIG. 6, in a position in which the heat-sensitive detent means has brought about the opening of the device, unblocking the outlet of water from the tap.

The present invention is based on an installation for the consumption of running water of known type, which in the particular case of the example shown in FIG. 1 corresponds to a running water installation of a residential property, of known type, consisting of a first common section 1 which, as can be seen in FIG. 1, presents in this case a shutoff key 19 and a pressure regulator 20 for the system, a hot water circuit 2 with a boiler system 22, a cold water circuit 3, and at least one water dispensing point 4, in this case a tap for hot and cold water.

As a characteristic of the present invention, the tap 4 is provided with a device 5 which can be actuated by the user. In the example shown in FIG. 2, the actuation of the device is effected by a button 6 provided with a spring.

The installation according to this invention is also characterised by the cold water circuit 3 operating at a pressure lower than that of the hot water circuit 2. In the case of the particular embodiment shown in FIG. 1, this is achieved by means of a pressure regulator 7 located at the start of the cold water circuit 3. Likewise characteristically, the cold water circuit 3 possesses means for discharging the volume of water which may come via the device 5, to which reference is made in FIG. 1 by the number 8. Said device must be provided with means for setting it in motion when the device 5 allows for a volume deriving from the hot water circuit 2 to enter into the cold water circuit 3. In the example shown, this is effected by means of two electric valves 9, 9′, which simultaneously open the device 8 and close the entry of cold water to the circuit 3, said valves 9, 9′, being controlled by a pressure-sensitive mechanism 10, such as a pressure switch.

In a preferred manner, the present invention makes provision for the discharge device to include an intermediate tank 11. In the example shown, the intermediate tank 11 likewise possesses a level indicator 15 to indicate an excess or deficit of the filling of the device 11. A typical value of the capacity of said tank 11 for use in residential properties is approximately 50 litres.

Also in a preferred manner, the present invention makes provision for the water stored in the intermediate tank 11 to be recovered via the water consumption installation itself by means of a device, to which reference is made in FIG. 1 by the number 12, which connects the intermediate tank to the water installation. In the example shown, the device 12 comprises a pump 13 for pumping the water from the tank 11 to the circuit 3, which is controlled by a pressure switch 14. The reutilisation device 12 is likewise provided with a non-return valve 16, which prevents the tank from being filled via the water recovery device. In the example shown, and in order to provide perfect co-ordination between the discharge devices 8 and the reutilisation devices 12, provision has been made for a timer 17 and a relay 18 in the installation.

The method according to the invention is characterised in that it comprises the steps of transference of water deriving from the hot water circuit 2 to the cold water circuit 3 prior to the consumption of the hot water, and the subsequent recovery of the volume of water transferred to the cold water circuit 3. Said recovery comprises preferably a storage arrangement and a subsequent transfer to a water dispensing point of the installation via the water circuits.

As is explained in detail hereinafter, the installation from the example shown in FIG. 1 implements the step of transfer of the water deriving from the hot water circuit 2 to the cold water circuit 3 by the use of the economiser device 5 located at the water dispensing points (as well as by means of the difference in pressures between circuits 2 and 3), the storage being effected by the actuation of the discharge device 8 and achieving said transfer of the stored water by means of the reutilisation device 12.

When the user requires hot water, he actuates the device 5, which in the case of the example shown is effected by pressing the button 6. The device 5 allows for passage from the hot water circuit 2 to the cold water circuit 3 during the time set by the temperature-sensitive mechanisms of the device 5.

The functioning of the discharge device 8 in the example is as follows: When the hot water circuit 2 communicates with the cold water circuit 3, an increase in the pressure of the cold water circuit 3 is produced. This increase in pressure actuates the pressure switch 10, which in turn, via the timer 17, actuates the discharge device 8, opening the electric valve 9 of the inlet to the intermediate tank 11 and closing the electric valve 9′ for admitting water to the cold water circuit 3. In addition, by way of the relay 18 of the discharge device 8, the means for reutilisation 12 are disconnected, shutting off the signal from the pressure switch 14. This circuit situation is maintained for a period determined by the timer 17. The time determined by the timer can be fixed, for example, determined during the installation of the circuits 2 and 3, in such a way that the time determined will be greater than the time taken by the water deriving from the hot water circuit 2 to reach the required temperature at the most distant water dispensing point. As a variant, it is possible to make the duration of this situation dependent on the temperature-sensitive mechanisms, or on the pressure at a predetermined point of the water circuit, or including the position of the button 6.

The functioning of the reutilisation device 12 is as follows: When cold water is requested from the circuit 3 via the water dispensing point 4, turning on the tap 4 brings about a drop in the pressure of the circuit 3, which actuates the pressure switch 14. The signal deriving from the pressure switch 14 sets the pump 13 in action, which drives water from the tank 11 into the cold water circuit 3. When the tap 4 is turned off, the pump 13 brings about an increase in the pressure in the circuit 3, which in turn produces a signal deriving from the pressure switch 14 to the pump 13. The pressure level of the pressure switch 14 must be lower than that of the pressure switch 10. In another preferred embodiment, the functioning of the pump 13 can also be governed by a signal deriving from the level 15 of the intermediate tank 11, in such a way that the functioning of the pump 13 is prevented if the tank 11 does not have a certain level of water as required.

The preferred embodiment of the installation from FIG. 2 is a running water installation, of the type used in residential properties. The installation is comprised, as the example shown in FIG. 1, of a first common section 1, which exhibits a shutoff key 19 and a pressure regulator 20 for the installation, a hot water circuit 2 with a boiler system 22, a cold water circuit 3, and at least one water dispensing point 4, in this case a tap for hot and cold water. The tap 4 is provided with a device 5 which can be actuated by the user, and which brings into communication the hot water circuit 2 and the cold water circuit 3, as has been explained in the description to FIG. 1. The hot water circuit 2 operates at greater pressure than the cold water circuit 3. In the example, this is effected by means of the pressure regulator 7 located at the beginning of the cold water circuit 3.

The example shown also comprises, as shown in FIG. 1, the valve 9′ and the pressure switch 10, located in the cold water circuit.

In a manner characteristic of this embodiment, the discharge means 8 connect the cold water circuit 3 to a point of the installation located upstream of the hot water generator or boiler 22, which in the example is effected by means of a pump 13, which can be of similar characteristics to the pump used in FIG. 1 to draw water from the intermediate tank, and a non-return valve 23.

The pressure switch 10 governs the functioning of the valve 9 and of the pump 13 by way of the relay 24.

When the device 5 is actuated by means of the control button 6, the hot water circuit 2 and the cold water circuit 3 are connected, which causes an increase in the pressure of the cold water circuit 3. To increase the pressure, the pressure switch 10 connects the relay 24, which closes the valve 9′ and sets the pump 13 into operation. When the temperature of the water at the water dispensing point 4 is as required, the hot and cold water circuits remain disconnected. The action of the pump 13 causes the pressure to be reduced below the alarm level for the pressure switch 10, which stops the pump 13 and opens the valve 9′.

Thanks to this connection of the means of discharge 8 at a point located upstream of the boiler 22, it is possible to do without the intermediate storage device shown in FIG. 1. This simplifies the installation, reducing costs and saving space.

Another embodiment provided for, not shown in the Fig., consists of replacing the device 5 by a manual actuating valve, of known type, which connects the hot water circuit 2 and the cold water circuit 3, doing without temperature-sensitive means, it being the user who must determine when the temperature of the installation has reached the required value.

In this way, the investment costs are also reduced. While it is true that this improvement is accompanied by a certain reduction in terms of convenience for the user, it cannot be a disadvantage in certain types of installations, such as installations with low consumption index, such as second homes.

FIG. 3 shows a particular embodiment of the device 5. In this particular embodiment, the device 5 can be connected to any tap 4 from among those on the market, by means of standardised connectors or connections 29, 29′. The joint is covered by a decorative cover 21, from which protrudes only the control element 6, which in this example consists of a button actuated by a spring. If the button 6 is actuated, the device 5 brings the hot and cold water circuits into operation for a period of time determined by the temperature-sensitive means provided, such as a heat-sensitive spring. When the water deriving from the hot water circuit 2 reaches the required temperature, the device stops the communication between the hot water circuit 2 and the cold water circuit 3, and allows for the water to depart via the water dispensing point 4. In the particular case of the embodiment shown, the button 6 again returns to its initial position when the temperature of the hot water reaches the required temperature, indicating to the user that there is hot water available. A typical value of the temperature required for the water consumption installation in residential properties is 38° C.

In FIG. 5 to 7 a tap 31 is shown, to which a water-saving device 5 has been connected, according to the present invention, at the water outlet of the tap. The device can be connected to taps which are currently found in installations, simply by replacing the filter which taps have at the outlet by the device 5, so facilitating the conversion of a domestic running water installation into a water-saving installation according to the invention.

The composition and functioning of the device 5 are described hereinafter by reference to FIGS. 6 and 7. In these figures a section through the device 5 can be seen, the object of the present invention, in which its different elements can be identified. The said device 5 comprises a body which, for example, can be screwed to the tap 31, using the thread provided for the outlet filter from the tap and comprises a through-opening 40 for the passage of water, which can be closed off by a blocking mechanism, comprising a blocking element 39 and a spring 36 which exerts a force which causes the blocking element 39 to block the through-opening 40. The movement of the blocking element 39 is stopped by a detent means element, which comprises a detent means piece 42, which is provided with a runner into which is introduced an element of variable section or wedge 43, the movement of which is governed by the dilation of the heat-sensitive spring 37. A recover spring 41 exerts a resilient action on the detent means piece 42, which ensures that at any moment the wedge 43 is in contact with the upper end of the opening or runner of the piece 42 In this way it can be ensured that the detent means piece 42 responds with vertical ascending and descending movements to the horizontal movements of the piece 43. The device 5 can also be provided, as in the example shown, with a filter 34 at the water outlet.

The functioning of the device is as follows. Starting from the state with the through-opening 40 blocked, which is shown in FIG. 6, the user simultaneously opens the inlets to the tap 31 deriving from the hot and cold water circuits. This can be done in a simple manner by means of the control arrangement of currently known taps. In this position, the force of the spring 36, which tends to open the opening 40 is cancelled by the detent means 42, which is pushed downwards by the spring 41.

When the temperature of the water reaches a predetermined level, as shown in FIG. 7, the heat-sensitive spring 37 dilates and causes the movement of the wedge 43, which in turn causes the piece 42 to rise, with which the effect of the detent means disappears and the spring 36 displaces the blocking element 39, unblocking the opening 40 and allowing a jet of hot water 35 to emerge from the tap via the filter 34 of the device 5. For a better response by the mechanism to changes in temperature, the heat-sensitive spring can incorporate an extension of the probe 38, such as a strip or wire of heat-conductive material, which is introduced into the interior of the tap 31.

Starting from the position in FIG. 7, and once the user has turned off the tap 31, the user can, if he wishes, return the device 5 to the position of water-saving from FIG. 6 by pressing the control element or button 33, whereby the device 5 is again available to be used.

There are numerous variants of the example shown in FIG. 1, which fall within the scope of the present invention. Thus, for example, the means of discharge 8 can include a delivery pump from the tank 11, the functioning of which is governed by the pressure switch 10, in a manner similar to the way the valve 9 is controlled in the example shown. In this way, greater speed of transfer of water can be achieved from the hot water circuit 2 to the cold water circuit 3. It is also possible to use for this purpose the pump 13 for emptying the tank 11. In this case, a system of electric valves, controlled by means of the pressure switches 10 and 14, is installed at the intake and outlet of the pump 13, in such a way that the pump 13 fills the intermediate tank 11, or empties it, depending on whether hot or cold water are required respectively at the water dispensing point 4. In another variant, the installation may exhibit pressure switches 10 and 14 in the same device, while likewise the valves 9 and 9′ can be replaced by a three-way valve performing the same function. The time determined in the example shown by the timer 17 can, alternatively, be determined by the functioning of the device 5, or by the pressure or the temperature of a point in the cold water circuit 3, in such a way that the time during which the discharge device 8 is activated, and the re-use device 12 is deactivated, coincides with the communication time between the hot water circuit 2 and the cold water circuit 3. Other embodiments may do without the relay 18, and include the timer 17. Another possible variation consists of connecting the re-use device 12 between the intermediate tank 11 and the intake to the hot water circuit 2. It is also possible, for example, to do without the re-use device 12 or also to include the intermediate tank 11. In this case, the discharge device 8 can be reduced to one all-or-nothing pressure-controlled opening valve, in such a way that it opens when the pressure in the cold water circuit 3 falls to the pressure level of the hot water circuit 4, causing the water to be re-used in the other circuit or application. On the other hand, the invention is not limited to the individual installation shown in the figure and the installation can be applied, for example, to installations in residential properties which have centralised sanitary hot water, or includes installations in buildings with centralised circuits for hot and cold water.

There are numerous variants of the example from FIG. 2 which fall within the scope of the present invention. For example, in one alternative embodiment it is possible to dispense with the valve 9′, replacing it by a non-return valve, if this functioning cannot be realised by means of the regulator 7. In this way it is possible to connect directly the signal from the pressure switch 10 to the pump 13. The person skilled in the art will also perceive multiple combinations between the embodiments disclosed here.

It is likewise possible for the device 5, located at the water dispensing point, to be provided with other control elements, of known type, in order to regulate the temperature required for the hot water. It is also possible for it to have configurations different to those shown, and in particular for it to be integrated and form an assembly with a tap 31, 4. It is also possible to generate other known types of visual or audible signals to advise the user when the temperature at the water dispensing point 4 reaches the required temperature.

It is also possible for the control element 36 to be provided with a slot or flange (not shown) in order to take it out of service, in which case the device 5 is forced manually to unblock the opening 40 in order to return the device 22 to the position in FIG. 7. It is also possible to incorporate a mechanism in order to be able to determine the temperature of the water in an adjustable manner, causing a dilation in the heat-sensitive spring 37 such that the device opens. This can be achieved, for example, by means of a rotating piece inside the device, which causes torsion in the heat-sensitive spring 37, or by other known means. It is also possible to include electronic equivalents to the elements shown, such as replacing the heat-sensitive spring by a thermostat, and actuating the detent means system by means of the thermostat signal, such as by way of an electric valve or similar.

1. Installation for the consumption of running water, of the type comprising hot and cold water circuits and at least one water dispensing point common to both circuits, wherein:
the cold water circuit operates at lower pressure than the hot water circuit,
at least one device situated at a water dispensing point common to the hot and cold water circuits, which comprises a control element which can be actuated by the user and allows for the passage of the water from the hot water circuit to the cold water circuit via the water dispensing point, and
there are means located in the cold water circuit for the discharge of the volume of water deriving from the hot water circuit.

2. Installation according to claim 1, wherein the said device located at a common water dispensing point determines, by way of temperature-sensitive means, the time during which the two circuits will be in communication.

3. Installation according to claim 1, wherein the difference in pressure between the hot water circuit and the cold water circuit is brought about by means of a pressure regulator located in the cold water circuit.

4. Installation according to claim 1, wherein the means of discharge comprise devices for shutting off the intake of cold water to the cold water circuit and opening the discharge mechanism, and means sensitive to the pressure of the cold water circuit.

5. Installation according to claim 4, wherein the discharge means comprise time-sensitive means, which regulate the time of opening and closing the said devices for opening the discharge mechanism and closing the cold water circuit.

6. Installation according to claim 5, wherein the time-sensitive means comprise a timer, the actuation time of which is determined during installation.

7. Installation according to claim 2, wherein the means sensitive to the temperature of the said device located at a water dispensing point common to the hot and cold water circuits comprise a heat-sensitive spring.

8. Installation according to claim 1, wherein the said device located at a water dispensing point common to the hot and cold water circuits comprises connections which allow it to be connected to the taps known on the market.

9. Installation according to claim 1, wherein the means for the discharge of the volume of water deriving from the hot water circuit comprise a pump for delivering the volume of water deriving from the hot water circuit back to the installation again, and pressure-sensitive means which govern the starting and stopping of the pump.

10. Installation according to claim 1, wherein the means of discharge of the volume of water deriving from the hot water circuit of the installation comprises means for the transfer of water from the cold water circuit to a point of the installation upstream of a hot water generator located in the hot water circuit of the installation.

11. Installation according to claim 1, wherein the means for transferring the water comprise a pump, a non-return valve, and means sensitive to the pressure of the cold water circuit, which determines the functioning or stoppage of the said pump.

12. Installation according to claim 1, wherein the means located in the cold water circuit for the discharge of the volume of water deriving from the hot water circuit comprises an intermediate storage tank.

13. Installation according to claim 12, wherein the tank comprises at least a level detector to detect low level of filling and its capacity is approximately 50 litres.

14. Installation according to claim 13, wherein the installation comprises means for re-use which connect the intermediate tank to the cold water circuit.

15. Installation according to claim 14, wherein it has means sensitive to the level in the tank which prevent the pump from starting if the tank has not filled to the required safety level.

16. Installation according to claim 15, wherein it has means which prevent the said water re-use mechanism from operating if the water discharge mechanism is in operation.

17. Installation according to claim 16, wherein the said means which prevent the re-use mechanism from operating comprise a relay.

18. Method for the saving of water in installations for the consumption of running water of the type comprising hot and cold water circuits and at least one common water dispensing point, which comprises a transfer of water deriving from the hot water circuit to the cold water circuit by way of a water dispensing point, prior to the consumption of hot water, during a period of time such that, at the end of the transfer, the water from the hot circuit at the water dispensing point has the temperature required for its consumption, and subsequent provision of the volume of water transferred to the cold water circuit.

19. Method according to claim 18, wherein the provision of the water transferred to the circuit comprises the steps of intermediate storage and subsequent transfer to a water dispensing point of the installation via the water circuits.

20. Method according to claim 18, wherein the transfer of water from the cold water circuit to a point in the installation upstream of a hot water generator located in the hot water circuit of the installation.

21. Device for saving energy for the realization of an installation according to claim 1, for the realization of the method according to claim 18, of the type which can be connected to taps for common water dispensing points for hot and cold water circuits, which comprises a control element which can be actuated by the user and temperature-sensitive means by means of which the operating position of the device can be determined, wherein it comprises:
a body element which can be connected to the output from the tap;
a through-opening for the water proceeding from the tap to consumption;
a blocking element for the said through-opening;
means for causing the movement of the blocking element with the consequent unblocking of the through-opening; and
means for controlling the said movement of the said blocking element as a functioning of said temperature-sensitive means.

22. Device according to claim 21, wherein said temperature-sensitive means comprise a heat-sensitive spring.

23. Device according to claim 21, wherein said means for causing the movement of the blocking element comprise a spring.

24. Device according to claim 23, wherein said means of controlling said movement of said blocking element comprise a releasable detent means capable of exerting resistance to the force exerted by the spring on the means for causing the movement of the blocking element.

25. Device according to claim 24, wherein said user control element allows the user to position the device in a position in which the passage of water is blocked and the said detent means blocks the movement of the blocking mechanism.

26. Device according to claim 21, wherein it incorporates a filter at the water outlet.

27. Device according to claim 24, wherein said detent means mechanism comprises a piece of variable section, the movement of which is governed by the heat-sensitive spring, causing the movement of the said piece of variable section, and in turn the movement of a piece provided with a runner, into which said variable section is introduced, said piece effecting a detent action to the said blocking mechanism, as well as resilient recovery means which ensure the contact of the variable section element with one of the ends of the runner.

28. Device according to claim 25, wherein said control element consists of a button which can be actuated and which brings about the movement of the detent means mechanism into its position of blocking the said resilient force.

29. Device according to claim 28, wherein said control element is provided with a groove or flange in order to force the device manually to unblock the through-opening.

30. Device according to claim 21, wherein said temperature-sensitive means comprise a probe extension which is introduced into the interior of the tap.

31. Device according to claim 21, wherein it comprises a mechanism to determine, in an adjustable manner, the temperature at which said temperature-sensitive means bring about the unblocking of the through-opening.
